(19) United States
(12) Patent Application Publication
(10) Pub. No.: US 2006/0187229 A1
(43) Pub. Date: Aug. 24, 2006

(54) Page based rendering in 3D graphics system

(75) Inventors: Pingping Shao, San Jose, CA (US); Jiangbo Zhang, Mountain View, CA (US); Guofang Jiao, San Jose, CA (US); Jing Han, Santa Clara, CA (US); Tao Wang, Sunnyvale, CA (US); Ben (Hsueh-Ban) Lan, Cupertino, CA (US); Lingjun Chen, San Diego, CA (US)

Correspondence Address: Raymond Y. Chan, 108 N. Ynez Ave., #128, Monterey Park, CA, 91754, US

(73) Assignee: XGI Technology Inc. (Cayman)

(21) Appl. No.: 11/299,142

(22) Filed: Dec. 8, 2005

Related U.S. Application Data
(60) Provisional application No. 60/634,681, filed on Dec. 8, 2004.

(51) Int. Cl. G09G 5/36

(52) U.S. Cl. 345/553; 345/557

(57) ABSTRACT

A method of rendering 3D graphics image using page based rendering technique includes the steps of: dividing a plurality of primitives having respective primitive ID into a plurality of pages having respective page ID; sorting the primitives for each of the pages, and storing the sorted primitives into a page RAM under a plurality of page nodes which correspond with the sorted page IDs; matching incoming page IDs of the incoming primitive IDs with the page IDs stored in the page RAM in such a manner that when the incoming page ID of the incoming primitive matches with the sorted page ID stored in the page RAM, the incoming primitive are stored at the corresponding page node in the page RAM under the corresponding page ID; and rendering the primitives stored in the page memory into pixels displayed on the display screen.

### CROSS REFERENCE OF RELATED APPLICATION

This is a regular application of a provisional application, application number 60/634,681, filed Dec. 08, 2004.

### BACKGROUND OF THE PRESENT INVENTION

1. Field of Invention

The present invention relates to real time computer graphics, and more particularly to a rasterizer design in 3D graphics hardware architecture.

2. Description of Related Arts

In computer graphics, the algorithms of primitive rasterizer can be broadly divided into two categories: namely immediate mode rendering algorithms and tile based rendering algorithms.

For the immediate mode rendering algorithm, as shown in FIG. 1 and FIG. 2 of the drawings, primitives are immediately converted into pixels in the same order as the primitives are transferred by a particular application. In this way, some of the pixels may be occluded by subsequent primitives but they would be nevertheless transferred into frame buffer which is a portion of a memory chip of the particular computing system in question. As a result, the process of identifying and drawing hidden pixels which have been occluded consumes considerable memory bandwidth in the memory chip and constitutes a bottleneck for most of the graphics accelerators. It is suggested that primitives sorting according to the distance to eye can avoid overdraw of pixels, but some popular features such as Alpha blending must rely on the order of primitives, which inevitably consumes considerable amount of memory bandwidths in the above-mentioned fashion.

On the other hand, for the tile based rendering algorithm, as shown in FIG. 3 and FIG. 4 of the drawings, a whole screen is subdivided into tiles, and the primitives are first binned into each tile to form a plurality of tile buffers, which in turn is to be written into local memory. After all of the primitives of a frame finish binning in each tile, the relevant tile buffers are read and retrieved wherein the primitives binned in the respective tile buffers are sorted in the order of distance-to-eye, and then converted into a corresponding arrangement of pixels.

It is suggested that because the size of this tile is much smaller than the whole screen, the memory bandwidth that stores color buffer and Z buffer can be integrated into graphics chip. After all of the primitives of a particular tile are rendered, the color buffer and the Z buffer are subsequently written into local frame buffer. This saves memory access bandwidth for the color and Z.

After all tiles of a particular frame (the whole screen) have completed the pixel rendering process, the final image is sent to display unit which then displays the image in question to a user. It is suggested, this method is adapted for rapid hidden pixel removal and therefore saves processing time and memory resources.

Though these advantages, tile based rendering algorithm also has disadvantages. First, the primitives of the whole frame (screen) have to be stored into many tile buffers and are read many times since they are shared by multiple tiles. The duplicative primitives need a relatively big buffer to store and consumes considerable amount of memory bandwidths. Second, the use of tile based rendering algorithms involves repeated setup computations for each primitive when the primitive covers multiple tiles. Last, the primitive size of a frame is limited by the architecture of the tile based rendering algorithms.

### SUMMARY OF THE PRESENT INVENTION

A main object of the present invention is to provide a method of rendering a 3D graphic image using page based rendering technique, wherein each of the primitives is first divided into a plurality of segments which are binned in the same way as that of the tile based rendering technique, while the primitives of the whole frame are rendered in the same way as the immediate mode rendering technique, such that the page based rendering technique substantially integrates the advantages of both the immediate mode rendering technique and the tile based rendering technique, while resolving the respective disadvantages in associated with the these graphics rendering techniques.

Another object of the present invention is to provide a method of rendering a 3D graphics image using page based rendering technique, wherein the primitives are divided into pages and pre-sorted before they are converted into pixels, so as to avoid occlusion of pixels as a result of overlapping of primitives, such that the memory resources for implementing the method can be minimized.

Another object of the present invention is to provide a method of rendering a 3D graphics image using page based rendering technique, wherein the primitives are sorted and compared in a page-by-page basis, so that there is no need to repeatedly sort and store the primitives for the whole frame. In other words, the present invention provides an efficient and effective method for rendering a 3D graphics image.

Another object of the present invention is to provide a page based image rendering system which is capable of generating 3D graphics image by page based rendering technique

In order to accomplish the above objects, the present invention provides a method of rendering a 3D graphics image, comprising the steps of:

(a) dividing a plurality of primitives having respective primitive identifications (primitive IDs) into a plurality of pages having respective page identifications (page IDs), wherein each of the pages contains an uneven number of the primitives;

(b) sorting the primitives for each of the pages, and storing the sorted primitives into a page RAM under a plurality of page nodes which correspond with the sorted page IDs, wherein each of the sorted primitives is stored under one of the page nodes according with the respective page ID of the sorted primitives;

(c) matching incoming page IDs of the incoming primitive IDs with the page IDs stored in the page RAM, in such a manner that when the incoming page ID of the incoming primitive matches with the sorted page ID stored in the page RAM, the incoming primitive is stored at the corresponding page node under in the page RAM the corresponding page ID, wherein when the incoming page ID of the incoming primitive does not match with the sorted page ID, a new page node is created under the corresponding incoming page ID of the incoming primitive which is stored at the new page node; and

(d) rendering the primitives stored in the page memory into pixels which are displayed to form a 3D graphic image when the page RAM is less than a predetermined amount of capacity.

These and other objectives, features, and advantages of the present invention will become apparent from the following detailed description, the accompanying drawings, and the appended claims.

### BRIEF DESCRIPTION OF THE DRAWINGS

FIG. 1 is a conventional method of an immediate mode rendering system for rendering a 3D graphics image.

FIG. 2 is a schematic diagram illustrating an operation of the immediate mode rendering technique for rendering a 3D graphics image.

FIG. 3 is a conventional method of a tile based rendering system for rendering a 3D graphics image.

FIG. 4 is a schematic diagram illustrating an operation of the tile based rendering technique for rendering a 3D graphics image.

FIG. 5 is a flow diagram of a method of rendering a 3D graphics image using page based rendering technique according to a preferred embodiment of the present invention.

FIG. 6 is a schematic diagram of a method of rendering a 3D graphics image using page based rendering technique according to the above preferred embodiment of the present invention.

FIG. 7 is a schematic diagram of a method of rendering a 3D graphics image using page based rendering technique according to the above preferred embodiment of the present invention, illustrating the manner of which the 3D graphics image is rendered.

FIG. 8 is a schematic diagram of page matching according to the above preferred embodiment of the present invention.

FIG. 9 is a flow diagram of page matching according to the above preferred embodiment of the present invention.

FIG. 10 is an alternative mode of the method of rendering 3D graphics image using paged based rendering technique according to the above preferred embodiment of the present invention.

FIG. 11 is a schematic diagram of the method of rendering 3D graphics image using paged based rendering technique according to the above the first alternative mode, illustrating that how the tiles are sorted.

FIG. 12 is a schematic diagram of the method of rendering 3D graphics image using paged based rendering technique according to the above the first alternative mode, illustrating that how the tiles are flushed.

FIG. 13 is a schematic diagram of the method of rendering 3D graphics image using paged based rendering technique according to the above the first alternative mode, illustrating that the tiles sorting is completed.

FIG. 14 is a diagram illustrating a disposition of the Page RAM according to the above preferred embodiment of the present invention.

FIG. 15 illustrates the disposition of primitive bank.

FIG. 16 illustrates the disposition of the parameter bank.

FIG. 17 illustrates how tile sorting works.

FIG. 18 illustrates the disposition of the tile RAM.

FIG. 19 illustrates how the bin buffer works.

FIG. 20 is a schematic diagram of a method based on Primitive Bank and the Primitive Bank.

FIG. 21 is a schematic diagram illustrating interrelation between pages, bins, tiles and, pixels according to the above preferred embodiment of the present invention.

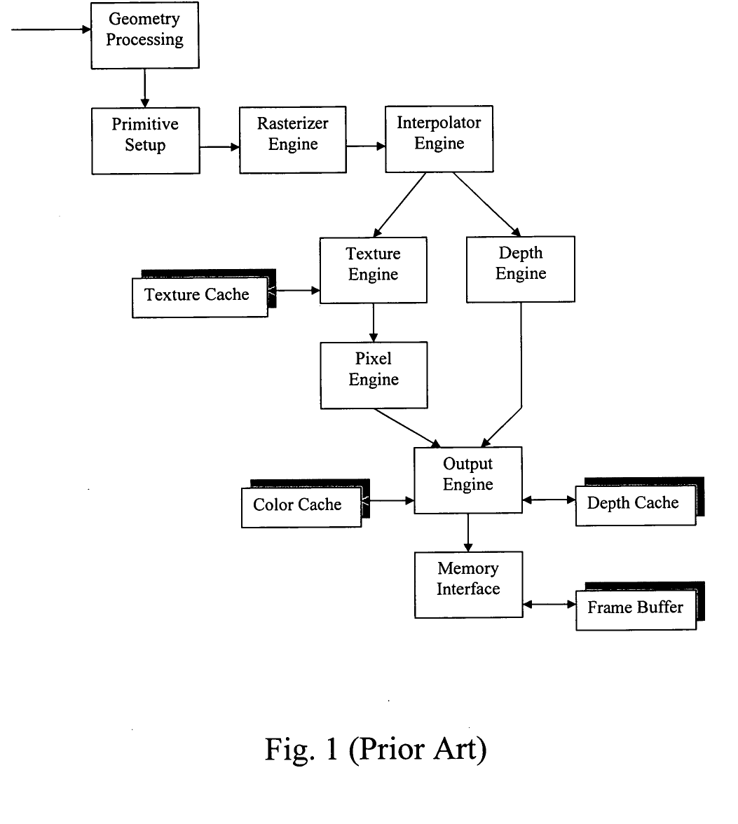

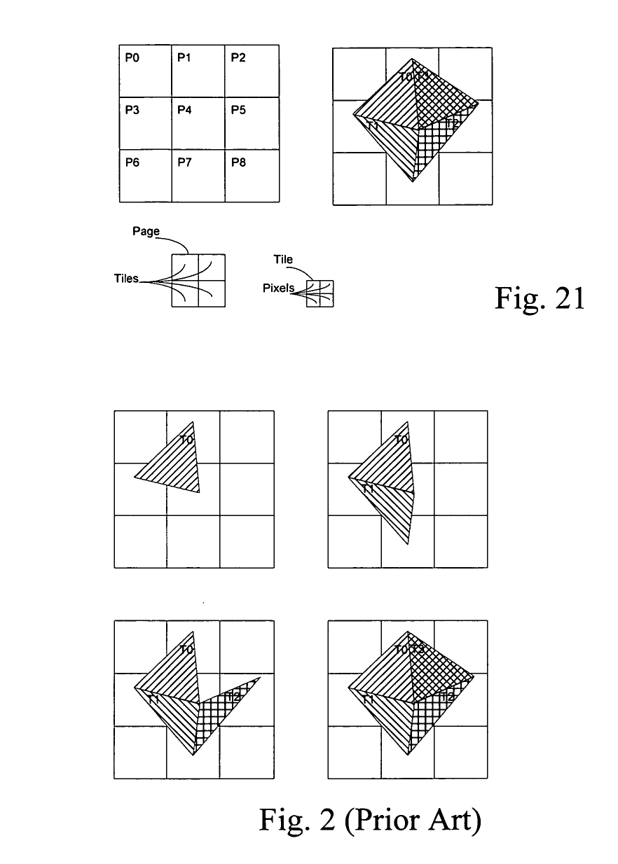

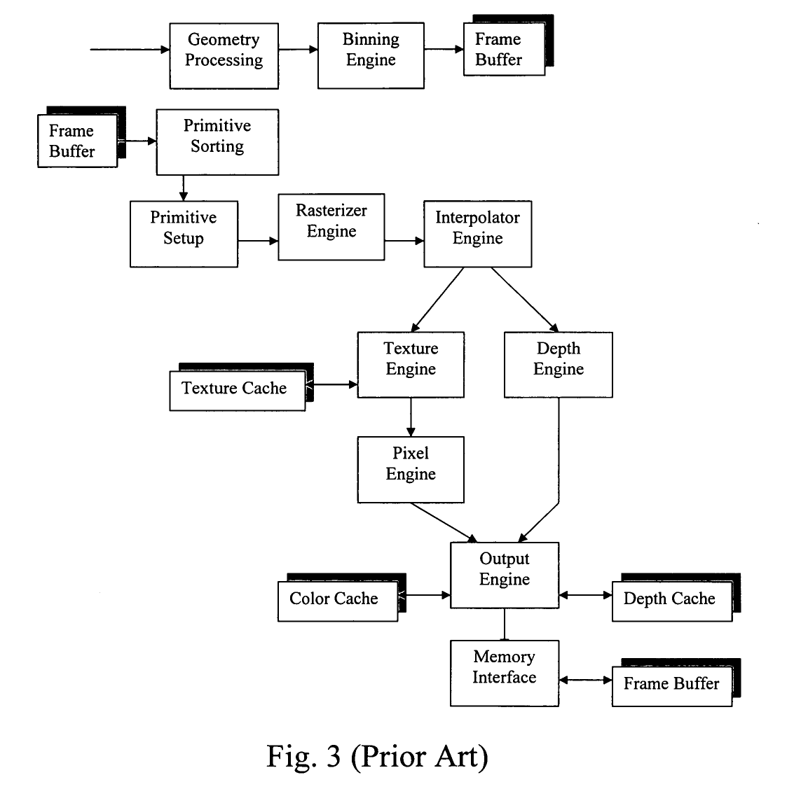

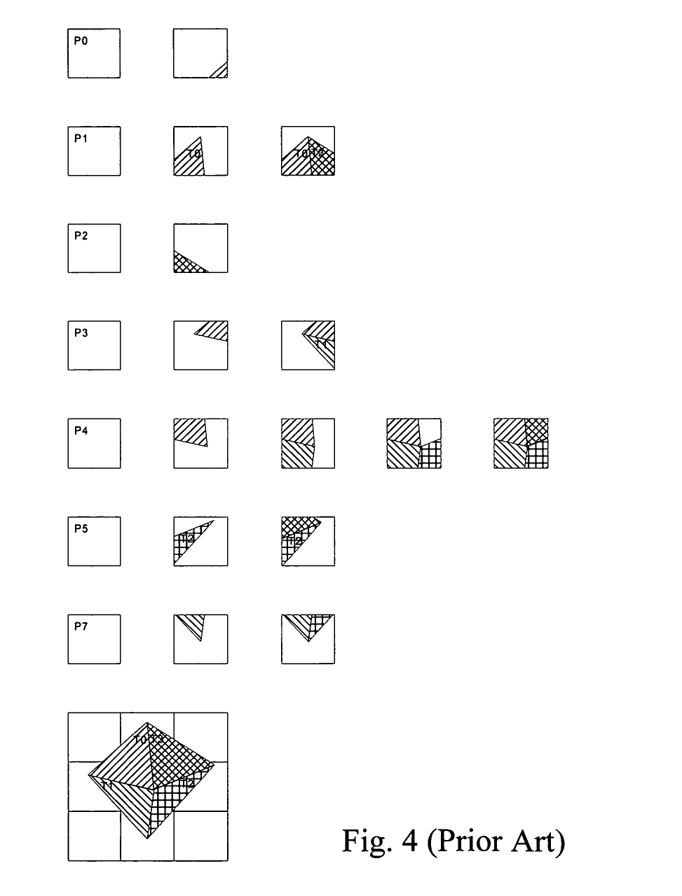

### DETAILED DESCRIPTION OF THE PREFERRED EMBODIMENT

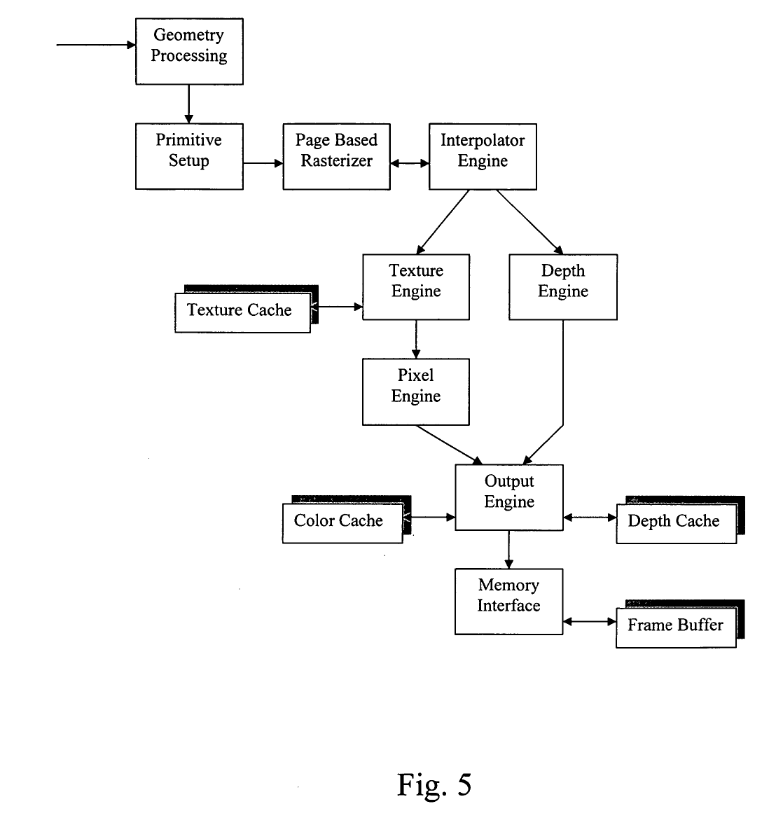

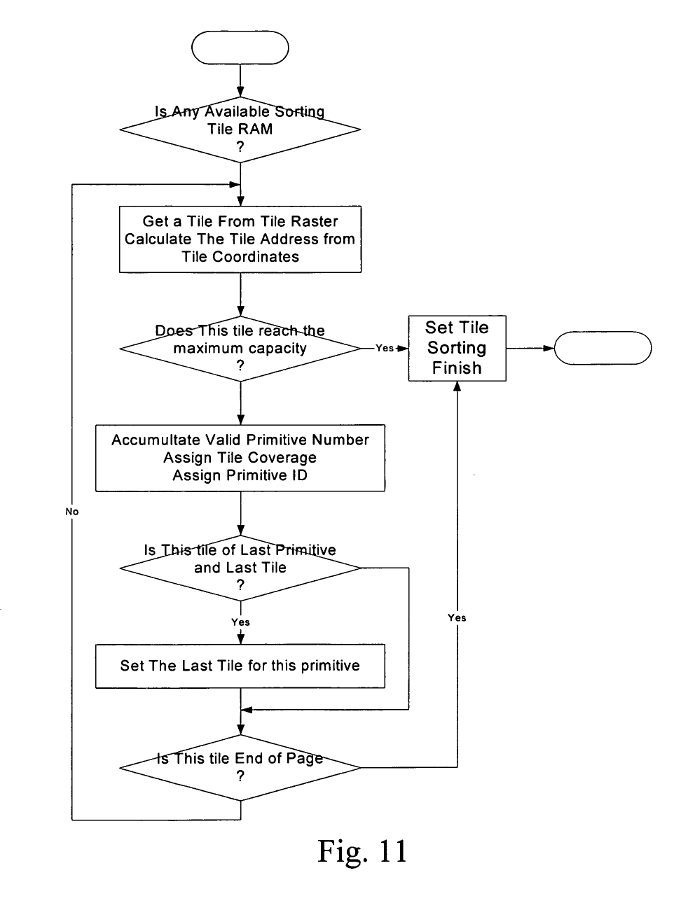

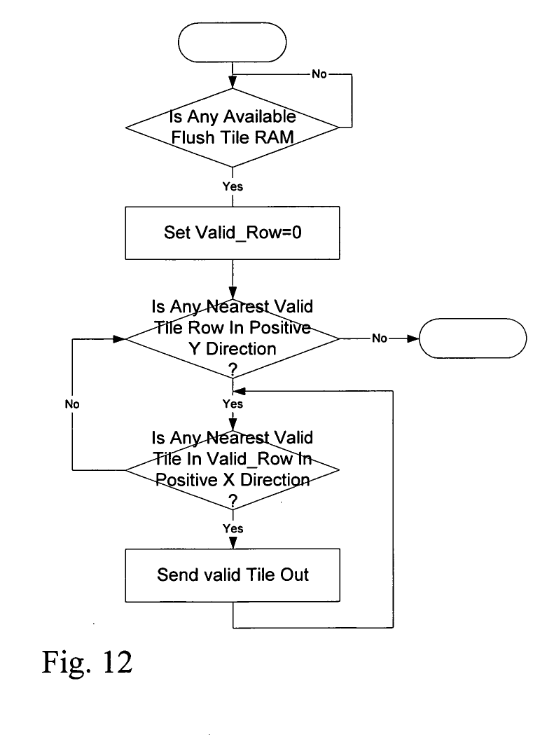

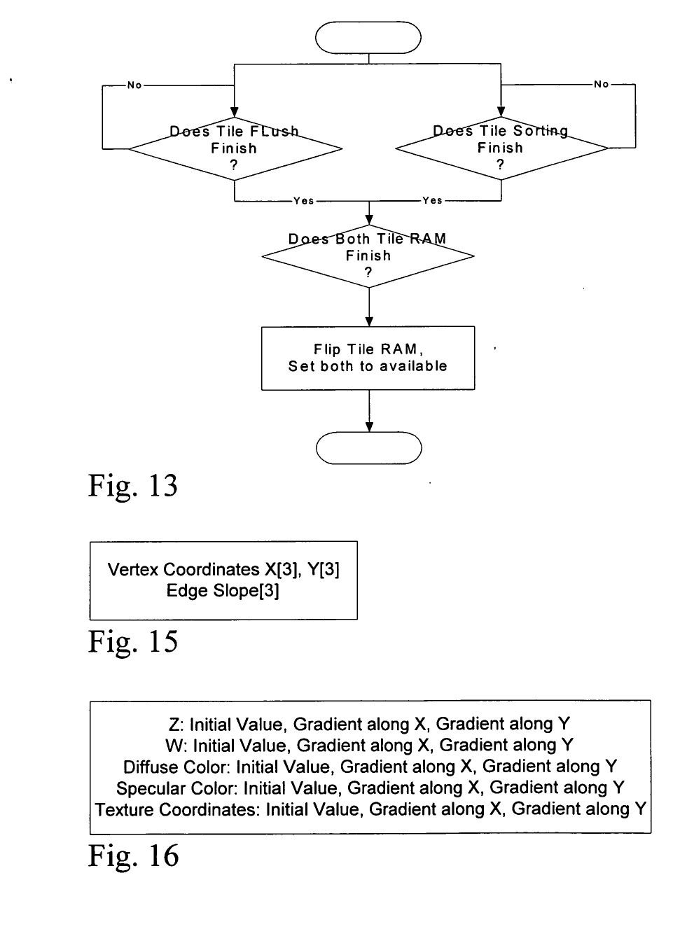

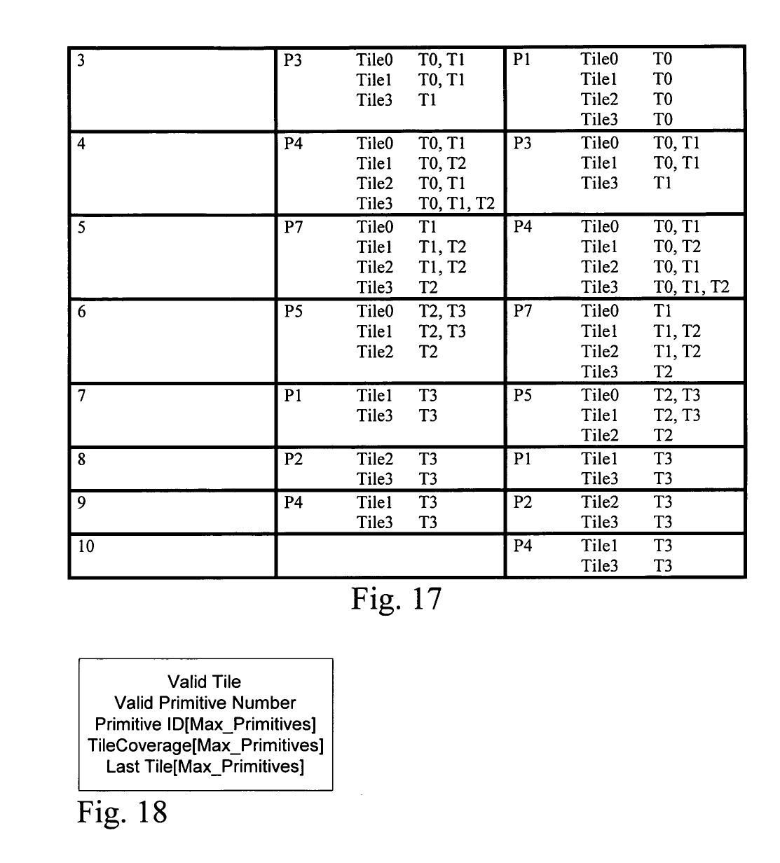

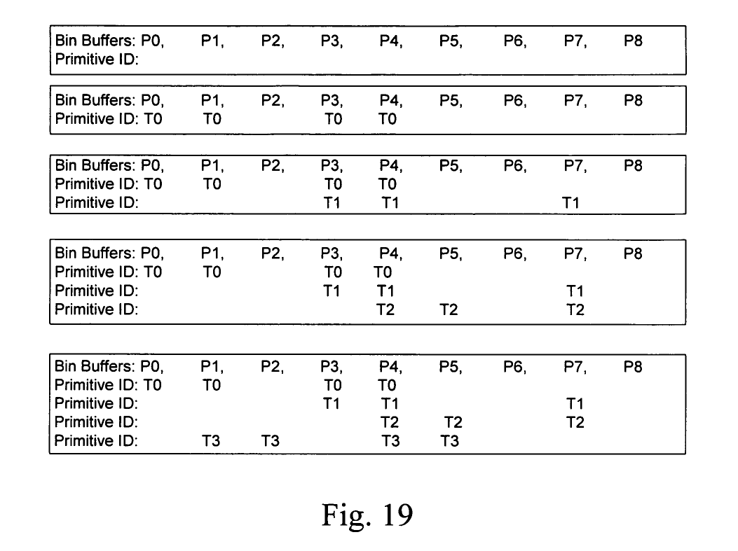

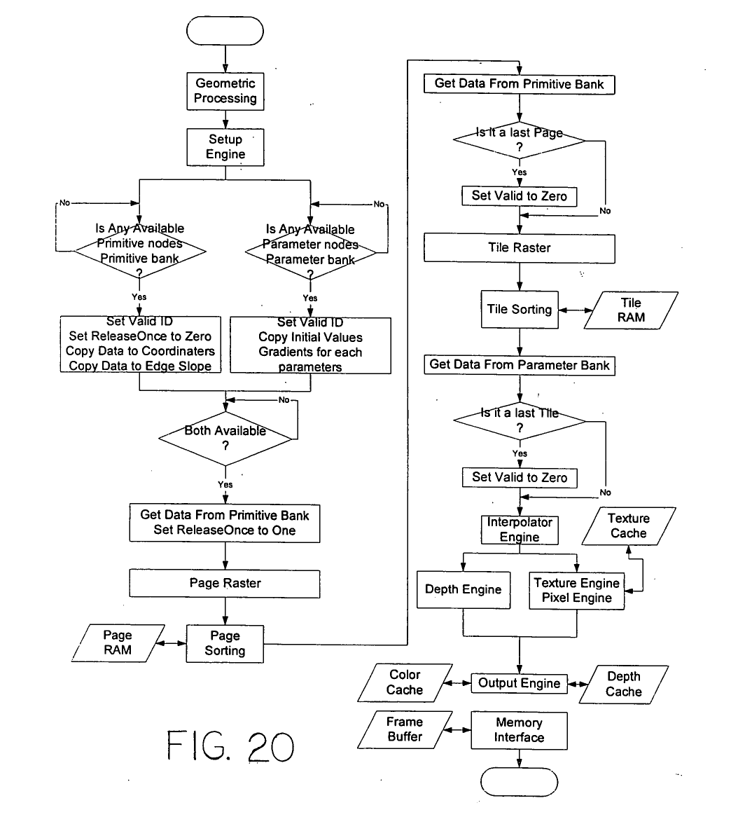

Referring to FIG. 5 to FIG. 21 of the drawings, a method of rendering 3D graphics image using page based rendering technique according to a preferred embodiment of the present invention is illustrated.

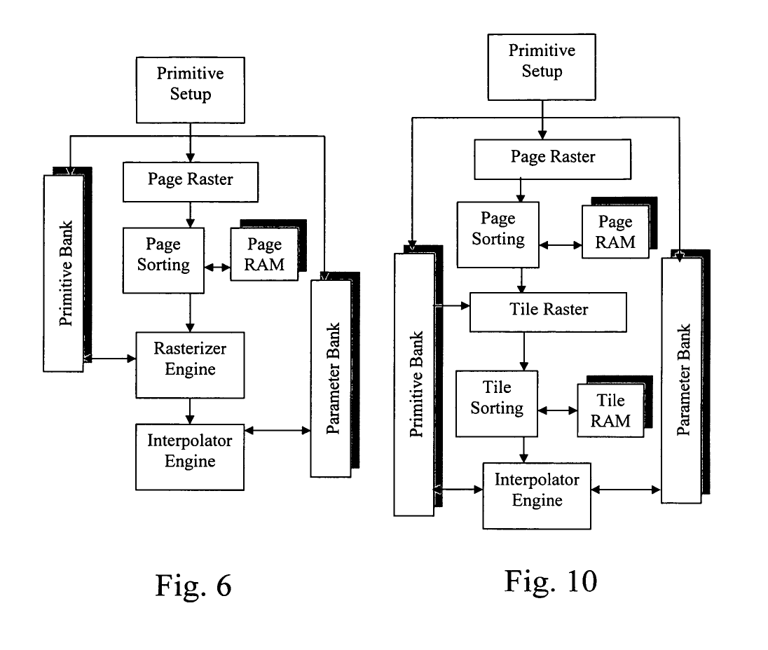

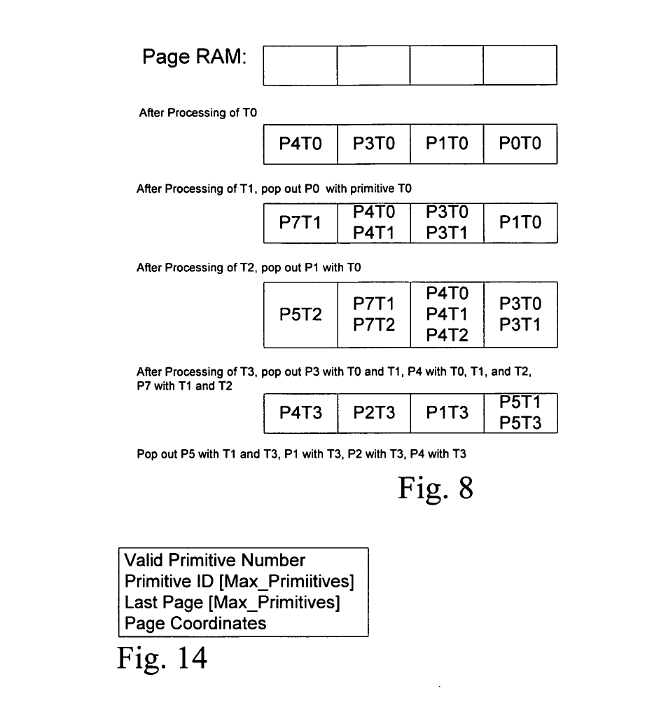

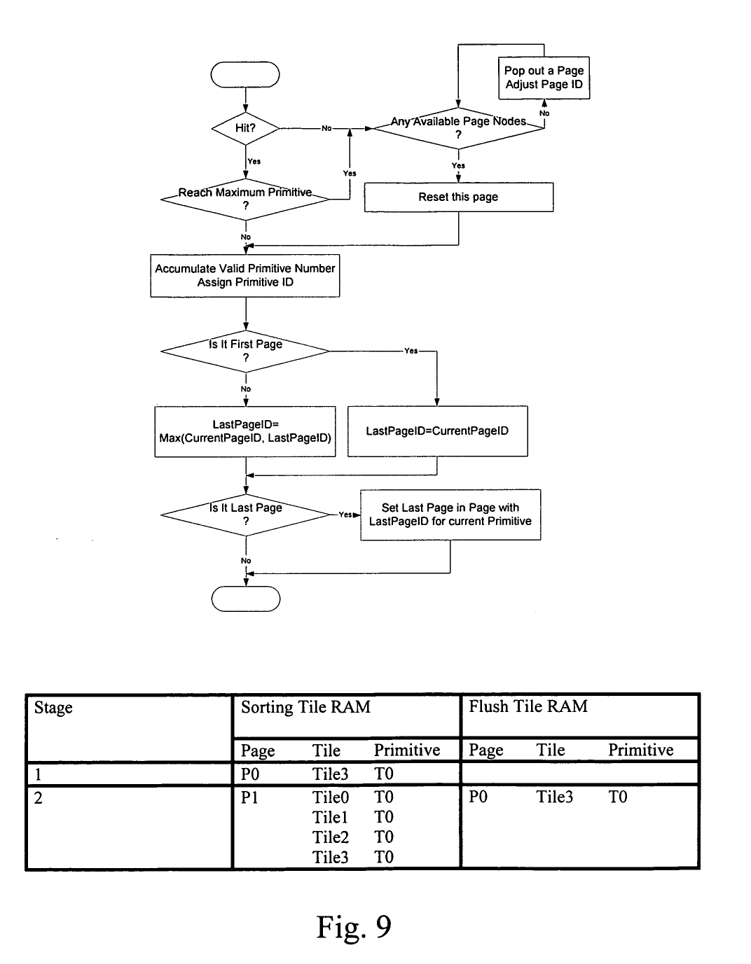

Referring to FIG. 5, FIG. 6, FIG. 8, and FIG. 9 of the drawings, the method, which is according to a preferred embodiment of the present invention, comprises the steps of:

(a) dividing a plurality of primitives having respective primitive identifications (primitive IDs) into a plurality of pages having respective page identifications (page IDs), wherein each of the pages contains an uneven number of the primitives;

(b) sorting the primitives for each of the pages, and storing the sorted primitives into a page RAM under a plurality of page nodes corresponding with the sorted page IDs, wherein each of the sorted primitives is stored under one of the page nodes according with the respective page ID of the sorted primitives;

(c) matching incoming page IDs of the incoming primitive IDs with the page IDs stored in the page RAM in such a manner that, when the incoming page ID of the incoming primitive matches with the sorted page ID stored in the page RAM, the incoming primitive is stored at the corresponding page node in the page RAM under the corresponding page ID, wherein when the incoming page ID of the incoming primitive does not match with the sorted page ID, a new page node is created under the corresponding incoming page ID of the incoming primitive which is stored at the new page node; and

(d) rendering the primitives stored in the page memory into pixels which are displayed to form a 3D graphic image when the page RAM is less than a predetermined amount of capacity.

Prior to the step (a), the primitives are pre-created and stored in a primitive bank which is to be retrieved for rendering the 3D graphics image. The primitives are divided into a numbers of segments represented by pages which are the basic building blocks for further processing. At the meanwhile, each of the primitives is designated by a primitive identification (ID) while each of the pages is designated by a page identification (ID).

In the step (b), the sorting the primitives for each of the pages is performed by a sorting device comprising a page sorting engine and a page RAM. The sorting of the primitives ID and the pages ID are transferred to the page RAM which is a one-chip memory, and stored as a predetermined page node. Page sorting engine checks incoming primitives' ID with the ones stored in the page RAM. Where the incoming primitive's page ID matches with the relevant stored page IDs, the incoming primitive would be stored to an existing node of the page RAM under the same ID. Where the incoming primitive's page ID does not match with any page ID stored in the page RAM, a new page node would be created for storing that new primitive's page ID under the corresponding primitive ID.

When the memory resources of the page RAM less than a predetermined amount, the page nodes, having the corresponding page IDs and the primitives stored under those page IDs, are sent to a tile raster. The tile raster receives page IDs and the primitive list from the page nodes and renders all the primitives of the page nodes.

Specifically, the tile raster is adapted to convert the primitives into many tiles which cover the whole display screen. According to the preferred embodiment of the present invention, a total of sixteen (16) tiles are utilized for the purpose of primitives storage and division.

Referring to FIG. 5 to FIG. 6 of the drawings, according to the preferred embodiment of the present invention, the step (d) comprises the steps of:

(d.1) creating a plurality of tiles for the display screen;

(d.2) interpolating depths, colors, and texture coordinates for each pixel within each of the tiles;

(d.3) calculating pixel colors, pixel depths and pixel texture for each of the primitives stored in the page RAM, and loading the pixel colors and the pixel depths into a color cache and a depth cache respectively; and

(d.4) generating corresponding pixels with respect to the pixel colors and the pixels depths for each of the tiles to produce a 3D graphics image.

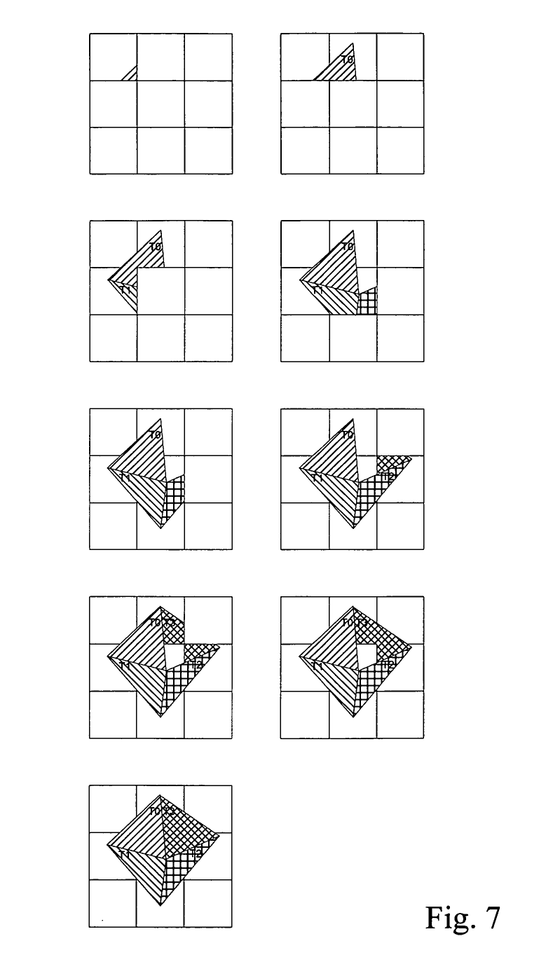

According to the preferred embodiment, the data of tiles to be created are sent to the tiling engine directly. Tiling Engine interpolates depths, colors, and texture coordinates for each of the pixels of each of the tiles. These data then go through texture engine and pixel shader to calculate the pixel color and the pixel depth. The pixel color and the pixel depth are written into color cache and depth cache and finally written into a frame buffer. FIG. 7 illustrates the manner of which the 3D graphics image is rendered, wherein the display screen is divided into a plurality of tiles, while each of the pages is formed by a predetermined number of tiles, and each tile contains a predetermined number of pixels.

Referring to FIG. 10 to FIG. 13 of the drawings, and by reference to FIG. 14 to FIG. 21 of the drawings, an alternative mode of the method of rendering a 3D graphics image using page based rendering technique according to the preferred embodiment of the present invention is illustrated. The alternative mode is similar to the preferred embodiment except that the method further comprises the steps, in between step (c) and step (d), of:

(c.1′) converting the primitives in the page RAM into a plurality of tiles, wherein each of the tiles has a predetermined number of coverage masks determined by a Tile Raster;

(c.2′) sorting the tiles and storing the sorted tiles in a tile RAM;

(c.3′) verifying the number of primitives for each of the tiles, in such a manner that when the number of primitives exceeds a predetermined number, the corresponding tile is flushed into another tile.

Note that the number of primitives for each of the tiles should be a matter of customarily discretion, yet according to the preferred embodiment of the present invention, a tile of 4×4 is utilized.

Moreover, the tile RAM has nodes for all tiles on a page, each slot store up to 4 pairs of the coverage masks containing the respective primitive IDs. Tile Sorting updates the number of the primitives to take into account the incoming data. If the maximum primitive's count of the tile reaches 4, this single tile is flushed in to next engines. And when all primitives raster are done, the tiles of whole page are sent into Tiling Engine in the spatial order.

From the forgoing descriptions, it can be shown that the present invention also provides a page based 3D graphics rendering system for a displaying screen which is divided into a plurality of tiles, comprising a primitive bank 10, a page sorting device 20, and an interpolator engine 30.

The primitive bank 10 stores a plurality of primitives having respective primitive IDs, wherein the primitives are divided into a plurality of pages having respective page IDs.

The page sorting device 20 is electrically connected with the primitive bank 10 and adapted to sort the pages of the primitives with respective to the pages IDs.

The interpolator engine 30 electrically communicated with the page sorting device 20 for rendering the primitives sorted in the page sorting device into pixels which are displayed on the display screen in the tiles to form a 3D graphic image.

According to the preferred embodiment, referring to FIG. 6 of the drawings, the page sorting device 20 comprises a page sorting engine 21 and a page RAM 22 electrically communicated with the primitive bank 10, wherein the sorting of the primitives for each of the pages is performed by the page sorting engine 21. The sorted primitives ID and the pages ID are transferred to the page RAM 22 which is preferably a on-chip memory, and stored as a predetermined page node. Page sorting engine 21 checks incoming primitives' ID with the ones stored in the page RAM 22. Where the incoming primitive's page ID matches with the relevant stored page IDs, the incoming primitive would be stored to an existing node of the page RAM 22 under the same ID. Where the incoming primitive's page ID does not match with any page ID stored in the page RAM 22, a new page node would be created for storing that new primitive's page ID under the corresponding primitive ID.

The interpolator engine 30 comprises a tile raster 31 adapted to render all primitives of the page nodes. Specifically, when the memory resources of the page RAM 22 less than a predetermined amount, the page nodes, having the corresponding page IDs and the primitives stored under those page IDs, are sent to a tile raster 31. The tile raster 31 receives page IDs and the primitive list from the page nodes, and renders all primitives of the page nodes.

The tile raster 31 is adapted to convert the primitives into many tiles which cover the whole display screen. According to the preferred embodiment of the present invention, a total 16 tiles are utilized for the purpose of primitives storage and division.

As shown in FIG. 5 to FIG. 21 of the drawings, from the forgoing descriptions, it can be seen that the objects of the present invention have been accomplished. The present invention provides a method and a system for rendering 3D graphics image using page based rendering technique, which substantially resolves the shortcomings of the conventional 3D graphics image rendering techniques.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of rendering a 3D graphics image on a display screen, comprising the steps of:
(a) dividing a plurality of primitives having respective primitive identifications (primitive IDs) into a plurality of pages having respective page identifications (page IDs), wherein each of said pages contains an uneven number of said primitives;
(b) sorting said primitives for each of said pages, and storing said sorted primitives into a page RAM under a plurality of page nodes corresponding with said sorted page IDs, wherein each of said sorted primitives is stored under one of said page nodes according with said respective page ID of said sorted primitives;
(c) matching incoming page IDs of said incoming primitive IDs with said page IDs stored in said page RAM in such a manner that when said incoming page ID of said incoming primitive matches with said sorted page ID stored in said page RAM, said incoming primitive is stored at said corresponding page node in said page RAM under said corresponding page ID, wherein when said incoming page ID of said incoming primitive does not match with said sorted page ID, a new page node is created under said corresponding incoming page ID of said incoming primitive which is stored at said new page node; and
(d) rendering said primitives stored in said page memory into pixels which are displayed to form a 3D graphic image when said page RAM is less than a predetermined amount of capacity.

2. The method, as recited in claim 1, wherein said step (d) comprises the steps of:
(d.1) creating a plurality of tiles for said display screen;
(d.2) interpolating depths, colors, and texture coordinates for each of said pixels within each of said tiles;
(d.3) calculating pixel colors, pixel depths and pixel texture for each of said primitives stored in said page RAM, and loading said pixel colors and said pixel depths into a color cache and a depth cache respectively; and
(d.4) generating corresponding pixels with respect to said pixel colors and said pixels depths for each of said tiles to produce said 3D graphics image.

3. The method, as recited in claim 2, wherein further comprising the steps, between said step (c) and said step (d), of:
(c.1′) converting said primitives in said page RAM into a plurality of tiles, wherein each of said tiles has a predetermined number of coverage masks determined by a tile raster;
(c.2′) sorting said tiles and storing said sorted tiles in a tile RAM; and
(c.3′) verifying a number of primitives for each of said tiles in such a manner that when said number of primitives exceeds a predetermined number, said corresponding tile is flushed into another of said tiles.

4. The method, as recited in claim 3, wherein said tile RAM is adapted to store at most four pairs of said coverage masks containing said respective primitive IDs.

5. A paged based 3D graphics rendering system for a display screen divided into a plurality of tiles, comprising:
a primitive bank which stores a plurality of primitives having respective primitive IDs, wherein said primitives are divided into a plurality of pages having respective page IDs;
a page sorting device electrically connected with said primitive bank and adapted to sort said pages of said primitives with respective to said pages IDs; and
an interpolator engine electrically communicated with said page sorting device for rendering said primitives sorted in said page sorting device into pixels which are displayed on said display screen in said tiles to form a 3D graphic image.

6. The page based 3D graphics rendering system, as recited in claim 5, wherein said page sorting device comprises a page sorting engine and a page RAM electrically communicated with said primitive bank wherein a sorting of said primitives for each of said pages is performed by said page sorting engine and said sorted primitives ID and the pages ID are transferred to said page RAM and stored as a predetermined page node in such a manner that when an incoming primitives an incoming primitive's page ID matches with said one of said stored page IDs, said incoming primitive is stored to said page node of said page RAM under said page ID, wherein when said incoming primitive's page ID does not match with said page ID stored in said page RAM, a new page node is created for storing said incoming primitive's page ID.

7. The page based 3D graphics rendering system, as recited in claim 6, wherein said interpolator engine comprises a tile raster adapted to render said primitives of said page nodes in such a manner that said tile raster is adapted to convert and bin said primitives into said tiles of said display screen for rendering said 3D graphics image.
